(19) United States
(12) Patent Application Publication
(10) Pub. No.: US 2013/0161266 A1
(43) Pub. Date: Jun. 27, 2013

(54) SYSTEM AND METHOD FOR TREATING EFFLUENT WITH MICROWAVE GENERATED MULTI-BUBBLE PLASMA

(71) Applicants: Mahesh Chandran, Bangalore (IN); Nagaveni Karkada, Bangalore (IN); Laurent Cretegny, Niskayuna, NY (US); Vasile Bogdan Neculaes, Niskayuna, NY (US); Brian Christopher Moore, Mechanicville, NY (US)

(72) Inventors: Mahesh Chandran, Bangalore (IN); Nagaveni Karkada, Bangalore (IN); Laurent Cretegny, Niskayuna, NY (US); Vasile Bogdan Neculaes, Niskayuna, NY (US); Brian Christopher Moore, Mechanicville, NY (US)

(73) Assignee: GENERAL ELECTRIC COMPANY, Schenectady, NY (US)

(21) Appl. No.: 13/334,168

(22) Filed: Dec. 22, 2011

(51) Int. Cl. C02F 1/30; C02F 1/36

(52) U.S. Cl. 210/748.02; 210/748.07

(57) ABSTRACT

A method for utilizing microwave generated multi-bubble plasma to treat an effluent is provided. The method comprises: providing a microwave field; flowing an effluent and gas bubbles in the effluent across the microwave field; enhancing electromagnetic field in a path of the gas bubbles in the microwave field via an electrode; triggering plasma in the gas bubbles as the gas bubbles reach a region of enhanced electromagnetic field; and coupling microwave to the plasma.

### BACKGROUND

The present invention generally relates to a system and method for treating an effluent with plasma, and, more specifically, to a system and method for treating an effluent with microwave generated multi-bubble plasma.

Many industrial processes produce large volumes of effluent that must be treated for removal of contaminants before being discharged back into natural reservoirs. Some examples include: (a) iron and steel industry, which employs water as a lubricant/coolant in various hot and cold mechanical transformation stages; (b) production of coke from coal in coking plants, which uses water as a coolant and for separation of by-products; and (c) brewage industry, where a large volume of effluent is produced.

Effluent from most of these industries may contain high concentrations of aliphatic and aromatic petroleum hydrocarbons. They may have very high biological oxygen demand (BOD) and chemical oxygen demand (COD), may be dark brown in color and acidic, and may have high solid content and bad odor, all of which may lead to pollution for the receiving water body.

Conventional methods used to eliminate polluting chemicals in water are based on biological, physical or chemical processes. The biological processes involve using microbes to activate biodegradation. Physical methods include filtration, adsorption on activated carbon, air stripping, membranes (micro-, ultra- and nano-filtration, as well as reverse osmosis), ion exchange etc. Chemical treatments include chemical precipitation (e.g. lime softening, precipitation with iron or aluminum salts), chlorination, ozonation, UV-based processes. However, these methods have certain limitations. For example, membrane-based technology may be fouled by free or emulsified oils or certain dissolved organic species, necessitating membrane cleaning or even membrane replacement. As an example, the presence of polyphenols and melanoidins in effluent generated in sugar industry has been shown to cause problems. While chemical precipitation may be cost effective for removing large molecular weight organics (10's or 100's of thousands of Daltons), it is not generally proficient for removal of compounds with molecular weights <1000 Da. Activated carbon can be very effective at removing organics, but is too costly to employ for high COD wastewaters. Advanced oxidation technologies based on the principle of photo-catalytic generation of highly reactive intermediates (e.g. hydroxyl radicals, oxygen ion) require UV radiation. For waters that are highly colored, the UV may have difficulty penetrating far into the water, slowing kinetics. Often, advanced oxidation processes are energy intensive. Considering the challenges ahead in the area of clean water, there continue to be a need for a more robust and reliable technique to remove non-biodegradable, and high concentration organic substance from industrial effluent.

Recently, plasma technology is starting to be applied to treat industrial effluents, and attracting a great deal of attention. The active species in the plasma allows for degradation/oxidation of both biodegradable and non-biodegradable organic substances in industrial effluents. These oxidized species can be eventually converted to carbon dioxide and water by further treatment. However, the need for high voltage and electric fields in the effluents has prevented its large-scale applications.

Therefore, there is a need for an improved method for using plasma to treat an effluent.

### BRIEF DESCRIPTION

Embodiments of the invention provide a method for utilizing microwave generated multi-bubble plasma to treat an effluent. The method comprises: providing a microwave field; flowing an effluent and gas bubbles in the effluent across the microwave field; enhancing electromagnetic field in a path of the gas bubbles in the microwave field via a metal electrode; triggering plasma in the gas bubbles as the gas bubbles reach a region of enhanced electromagnetic field; and coupling microwave to the plasma.

### BRIEF DESCRIPTION OF THE DRAWINGS

FIG. 1 is a schematic diagram of an exemplary system which comprises one reactor, for treating effluent with microwave generated multi-bubble plasma, in accordance with one embodiment of the present invention.

FIG. 2 is a schematic perspective diagram of the system of FIG. 1.

FIG. 3 is a schematic diagram of an exemplary system comprising more than one reactor in series, in accordance with one embodiment of the present invention.

FIG. 4 is a schematic diagram of another exemplary system comprising more than one reactor in series, in accordance with one embodiment of the present invention.

FIG. 5 is a schematic diagram of an exemplary system comprising more than one reactor in parallel, in accordance with one embodiment of the present invention.

FIG. 6 is a schematic diagram of an exemplary system comprising a series of multiple microwave plasma reactors, in accordance with one embodiment of the present invention.

FIG. 7 is a schematic diagram showing UV-visible spectra of methylene blue solution before and after microwave exposure in accordance with one embodiment of the present invention.

### DETAILED DESCRIPTION

Embodiments of the present disclosure will be described hereinbelow with reference to the accompanying drawings. In the subsequent description, well-known functions or constructions are not described in detail to avoid obscuring the disclosure in unnecessary detail.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” or “substantially”, is not to be limited to the precise value specified. In some instances, the approximating language may correspond to the precision of an instrument for measuring the value.

In embodiments of the invention, a system and method are provided for utilizing microwave generated multi-bubble plasma to treat an effluent containing contaminants. The effluent to be treated includes but not limited to wastewater, oil and industrial effluent.

In one embodiment, the system for utilizing microwave generated multi-bubble plasma to treat an effluent comprises a microwave plasma reactor where the effluent treatment is carried out and a waveguide for guiding microwaves from a microwave source to the reactor to form a microwave field. The reactor may comprise a structure such as a tube for an effluent containing gas bubbles to flow, an element such as a pump for driving the effluent to flow, and an electrode for enhancing the electromagnetic field in a path of the gas bubbles. The waveguide may be either single mode or multimode, and it may be any structure capable of guiding microwaves and may differ in geometry. There is a particular pattern of electromagnetic field in a waveguide, i.e., there are regions of electric field and magnetic field. In a single mode waveguide, the field pattern is mainly determined by the geometry of the waveguide. In multimode waveguides, the field patterns are more complex. The electrode adapted to enhance the electromagnetic field may be positioned depending on the field pattern of the waveguide used. For example, when a single mode waveguide is used, the electrode may be placed in a region of high electric field in the microwave field. When a multimode waveguide is used, the electrode may be placed in a position to concentrate the locally effective electromagnetic field.

The electrode may be configured in any suitable shape, and made from any suitable material, including but not limited to metals or metal-ceramic composites such as copper. Multiple electrodes may be utilized in one reactor. The electrode may be either solid, porous or hollow. In one embodiment, the electrode is porous or hollow to allow a gas to pass therethrough to generate bubbles in the effluent. Moreover, the electrode may be configured to have catalytic activity. In one embodiment, the electrode is coated with a catalytic material to help treat the effluent.

The electrode may be designed to have either higher or lower electric field enhancement factor, wherein the field enhancement factor is defined as the maximum electric field divided by the average electric field. The maximum electric fields for certain electrodes of given geometries can be calculated by known formulas. As the electric field would determine the ionization of the plasma species, the electrode design may be used to control the chemical species in plasma inside the gas bubbles by varying the electric field enhancement factor of the electrode. In one embodiment, the electrode has an electric field enhancement factor higher than 1.0, which represents that the electrode provides enhancement over the average field.

Microwave power may be pulsed. Benefits of using pulsed microwave power may include facilitating the production of smaller gas bubbles, reducing heat generation in the effluent, or allowing operating flexibility to allow microwave output or pulsing be related to process conditions or performance/treatment goals.

In certain embodiments, chemical additives may be employed to promote contaminant degradation prior to/during/in conjunction with treatment with microwave induced multi-bubble plasma. One such additive may be hydrogen peroxide. In certain embodiments, chemical additives capable of modifying conductivity of the effluent may be employed.

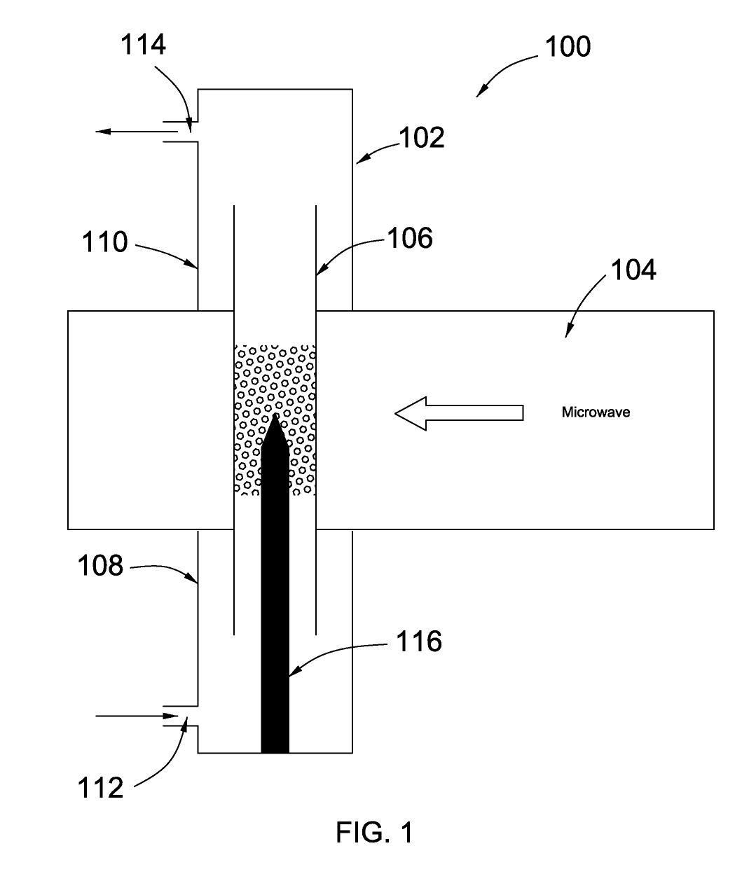

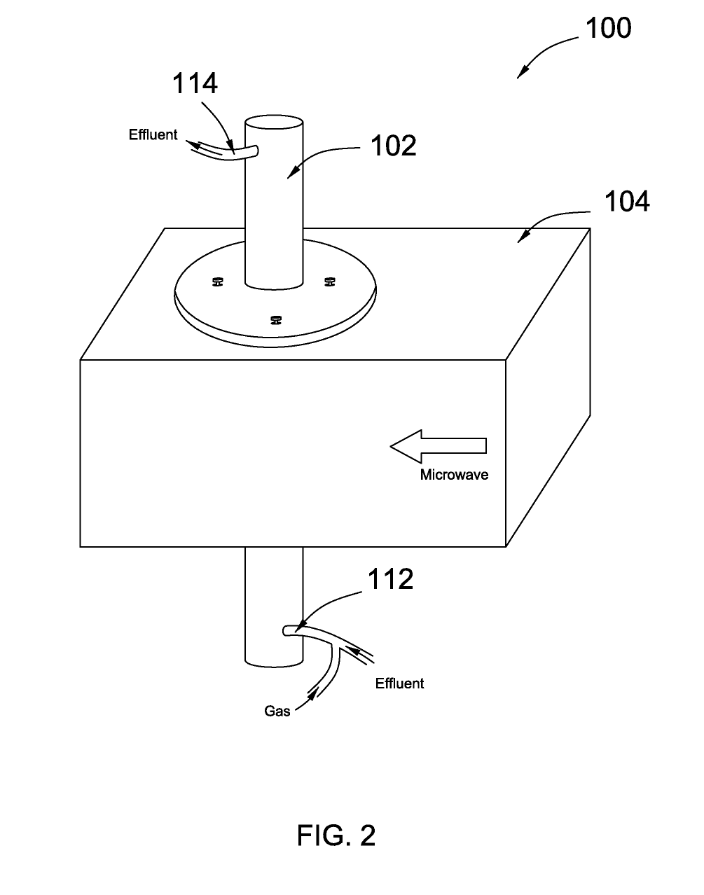

Referring to FIG. 1 and FIG. 2, a system 100 for utilizing microwave generated multi-bubble plasma to treat an effluent comprises a microwave plasma reactor 102 where the effluent treatment is carried out and a single mode waveguide 104 for guiding microwaves from a microwave source to the reactor 102 to form a microwave field. The reactor 102 is mounted on a section of the waveguide 104, as shown in FIG. 2, and comprises an open-ended tube 106 for an effluent to flow through, with opposites ends thereof capped by metal fittings 108 and 110 with provision for effluent inlet 112 and outlet 114, respectively. The reactor 102 is configured to enable an effluent to flow through the tube 106. In the illustrated embodiment, the reactor 102 is configured to enable an effluent to be pumped from the inlet 112 and drawn out from the outlet 114 using a peristaltic pump, and circulated in a closed-loop, ensuring the effluent keeping flowing in the tube 106. The effluent pumped from the inlet 112 may contain gas bubbles for creating plasma.

The tube is non-vacuum and the effluent treatment process can be performed at atmospheric pressure. Therefore the tube 106 for carrying the effluent may be made from any suitable material capable of withstanding a temperature of the effluent flowing therein and subjecting the effluent to the microwave. In one embodiment, the tube is made from a material transparent to the microwave. In a specific embodiment, the tube is made from quartz.

In one embodiment, the waveguide 104 starts from a microwave source such as a microwave generator (not shown), and terminated by an end plate (not shown). In one embodiment, the waveguide 104 is arranged to cross the tube 106 to guide microwaves across the tube 106. In a specific embodiment, the waveguide 104 and the tube 106 are arranged in a vertical manner.

An electrode 116 is adapted to enhance the local electromagnetic field in the path of the gas bubbles in order to trigger plasma in the gas bubbles. The electrode may be fixed or dispersed in the flowing effluent. The electrode may be particles dispersed in the flowing effluent and functioning as electrodes. In one embodiment, the particles may be kept localized within the reactor against the flow of the effluent by means of fluidization (i.e. setting upward flow through the reactor at a rate that keeps the particles suspended), magnetic force, or other means. Alternatively, the particles may flow through the reactor along with the effluent and there may be a downstream configuration to capture and recover the particles exiting the reactor. Some ways to capture the particles after exiting the reactors(s) include hydrocyclone, centrifuge, magnets, or filtration (e.g. ceramic filter, ceramic membrane, media filter, sieve, etc.). An advantage of having the electrode as dispersed particles is that, there would be more electrode surface area exposed to the effluent to generate the radicals. In the illustrated embodiment, the electrode 116 is attached to the lower metal fitting 108, and the electrode tip is positioned approximately halfway into the waveguide 104, and thereby is positioned around a middle of the microwave field along a direction that an effluent flows in the tube 106, where a maximum electric field of the microwave field is located.

When the system 100 is used to treat an effluent containing contaminants, the waveguide 104 guides microwave across the tube 106 to provide a microwave field, the effluent and gas bubbles in the effluent is passed across the microwave field. When the gas bubbles enter the microwave field around the electrode 116, where the electromagnetic field is enhanced by the discharge from the electrode 116, gas inside the bubbles break down to form the plasma. The triggering of plasma enables strong coupling of microwave to plasma, leading to absorption of microwave power by plasma. The microwave induced plasma may persist as long as the microwave power is on, and there may be multiple bubbles carrying the plasma throughout the whole process as the effluent and gas bubbles in the effluent flowing across the microwave field. The plasma provides radicals highly reactive towards contaminants and ability to degrade the contaminants in the effluent. The radicals may vary to target different contaminants by modifying the electromagnetic fields and the plasma composition.

To generate the gas bubbles, a gas may be provided to the effluent in the form of bubbles, before the effluent flowing across the microwave field. In the illustrated embodiment as shown in FIG. 2, a gas is injected into the effluent immediately before the effluent is pumped into the tube 106, using, for example, multiple sharp needles (not shown) to produce multiple bubbles that rises upward within the effluent due to buoyancy. Alternatively, the gas may be drawn into the effluent by use of a venturi. In an alternative embodiment, a gas may be pre-dissolved into the effluent before it enters the tube 106, wherein the pre-dissolving of the gas may be carried out at a pressure above atmospheric pressure. Additionally, there may be means to increase gas bubble density in the effluent. For example, the flowing effluent may be stirred the by mechanical mixing in order to increase gas bubble density. Moreover, there may be means to increase the resident time of gas bubbles in the high electric field region and/or means to increase the coupling of plasma to microwave. For example, in one embodiment, additional ultrasound waves are applied to oppose buoyancy forces on bubbles, so as to increase the resident time of gas bubbles in the high electric field region. The application of ultrasound waves also helps in increasing the coupling of plasma to microwave.

The gas can be chosen depending on the contaminants that need to be treated. Different gases may be used to target different contaminants in the effluent. For example, nitrogen gas may be used to target certain organic contaminants (e.g., methylene blue). Combination of gases may be used to target particular contaminants in the effluent.

To enhance the capability of treatment process or increase the process yield, system designs for scaling up the aforementioned process to treat contaminated effluent may be provided.

In certain embodiments, systems for treating an effluent by microwave induced plasma may comprise more than one microwave plasma reactors arranged in a serial manner such that the effluent can be continuously or sequentially treated by microwave induced plasma more than one times. More than one reactor may share a same microwave field, or may be subjected to different microwave fields. In other words, the effluent may be flowed across a microwave field more than one time, or be sequentially flowed across more than one microwave field.

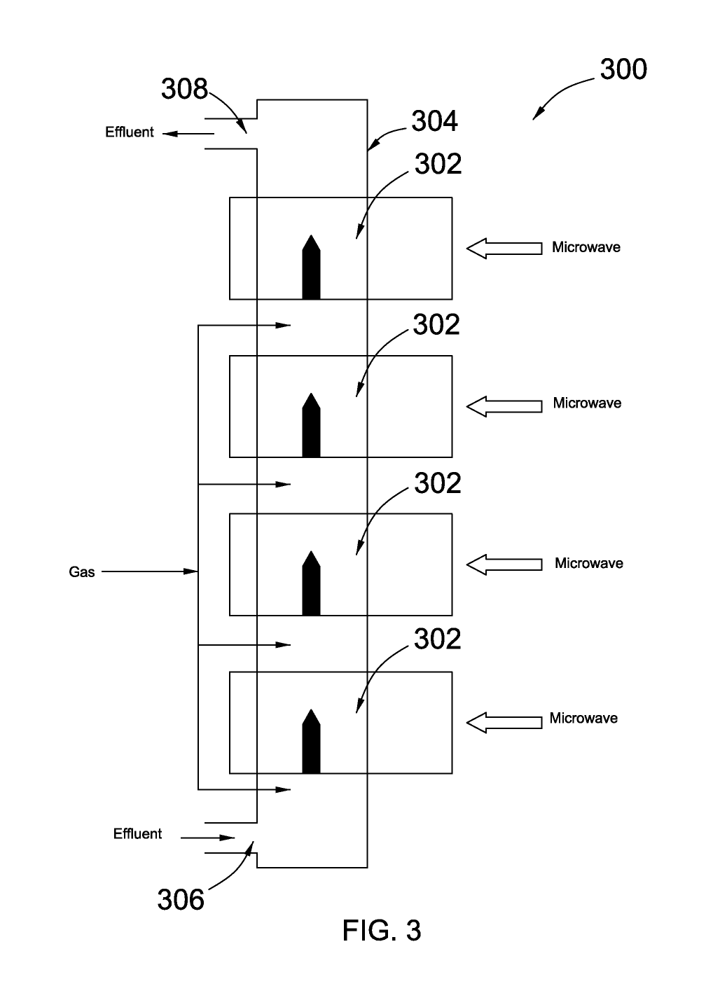

Referring to FIG. 3, a system 300 comprising a plurality of microwave plasma reactors 302 is provided. In the illustrated embodiment, four reactors 302 are provided in four sections of an elongated tube 304, which is provided with an inlet 306 and an outlet 308 around its opposite longitudinal ends, respectively. Each of the reactors 302 is coupled with a waveguide for guiding microwave to provide a microwave field, and comprises an electrode for enhancing the local electromagnetic field in the reactor. Additionally, each reactor 302 is provided with a gas inlet for injecting a gas to the effluent flowing therethrough to generate bubbles for creating plasma.

When the system 300 is used to treat an effluent, the effluent is pumped from the inlet 306 to the first reactor, where gas inside the bubbles break down to form the plasma when the gas bubbles enter the microwave field around the electrode, and therefore contaminations in the effluent are degraded by the plasma. The effluent coming out from the first reactor then proceed to the second reactor and is again treated by plasma generated in the second reactor, and therefore contaminations in the effluent are further degraded. By passing through the total four reactors, the effluent is treated by microwave induced plasma four times. Finally, the effluent coming from the last reactor is drawn out from the outlet 308. The gases injected to the four reactors may be either the same or different from each other. In one embodiment, different gases are injected to the four reactors to target different contaminations in the effluent.

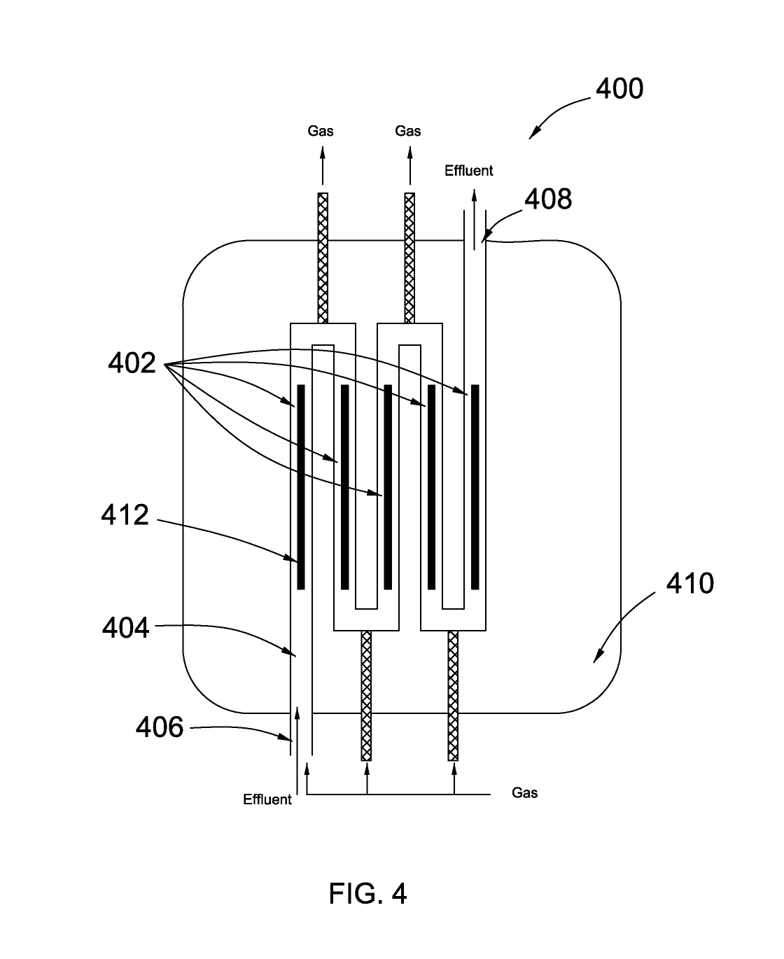

Referring to FIG. 4, another system 400 comprising a plurality of microwave plasma reactors is provided. In the illustrated embodiment, five reactors 402 are provided in five sections of a tube 404, which is provided with an inlet 406 and an outlet 408 around its opposite distal ends, respectively. The tube 404 has a shape as shown such that the five tube sections can be disposed in a multimode waveguide cavity 410. Each reactor 402 is provided with an electrode 412.

When the system 400 is used to treat an effluent, the effluent pumped from the inlet 406 sequentially flows through the five reactors 402, being treated by microwave induced plasma in each of the reactors 402, and lastly is drawn out from the outlet 408. In the illustrated embodiment, a gas is injected to the first reactor along with the effluent from the inlet 406, and additional supply of gas is provided to the other reactors.

In certain embodiments, systems comprising parallel microwave plasma reactors for simultaneously treating more than one stream of effluent may be provided to increase the yield.

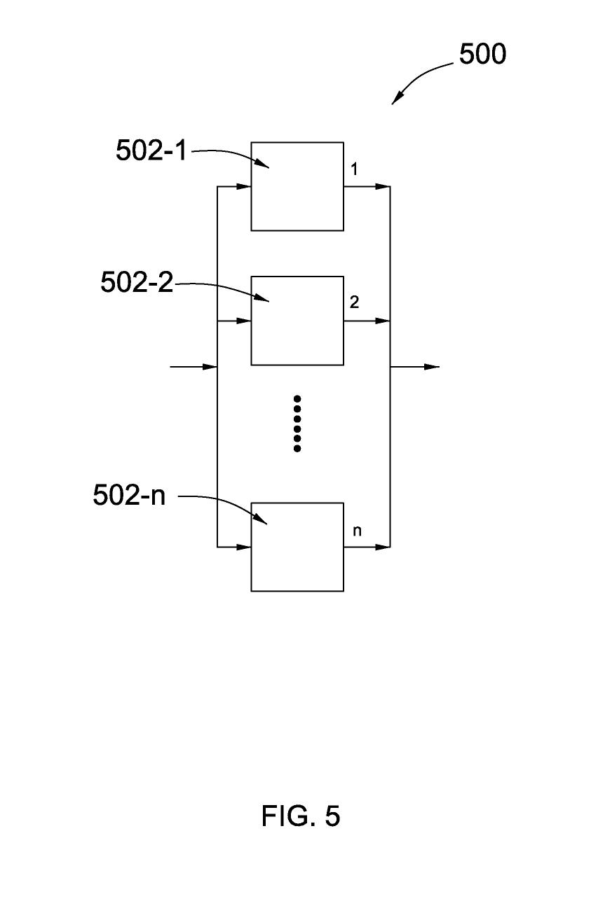

Referring to FIG. 5, a system 500 comprising a plurality of parallel microwave plasma reactors is provided. In the illustrated embodiment, the system 500 comprises n parallel arranged reactors 502-1, 502-2 . . . 502-n. Each of the reactors is capable of independently treating a stream of effluent using microwave induced plasma. In one embodiment, the plurality of reactors may share a multimode waveguide cavity. In an alternative embodiment, different reactors may be coupled with different waveguides.

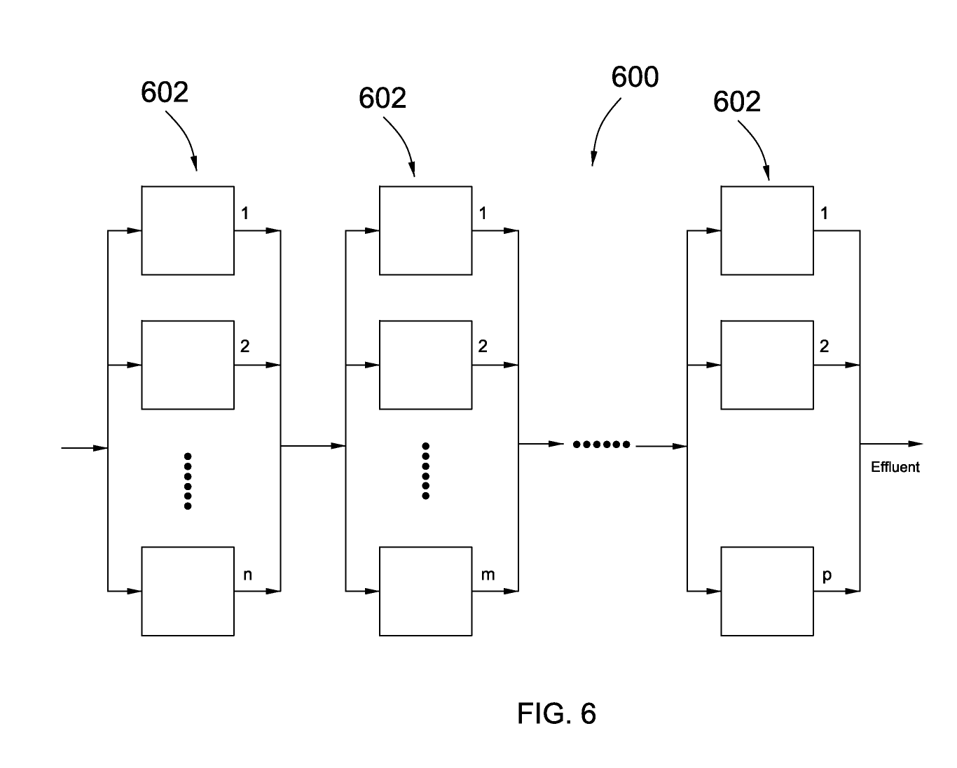

In certain embodiments, systems may comprise a series of multiple microwave plasma reactors. The multiple reactors may be arranged in a variety of configurations such as the parallel configuration shown in FIG. 6. FIG. 6 is illustrative of a system 600 comprising a plurality of reactor groups 602. Each reactor group 602 comprises at least one microwave plasma reactor. Two or more reactors in a group are parallel arranged in such a manner that each of them is capable of independently treating a stream of effluent using microwave induced plasma. Process conditions and parameters of each reactor, including but not limited to electromagnetic field, plasma composition, effluent flow velocity, gas bubble size and gas bubble density may be controlled independently from the other reactors.

In certain embodiments, the system may further comprise a pre-filter used in conjunction with the microwave plasma reactor(s) to remove suspended solids that may interfere with plasma generation or efficiency of plasma generation.

In certain embodiments, the system may further comprise a post-filter used in conjunction with the microwave plasma reactor(s) to remove suspended solids from the effluent after exiting the reactor, or between reactors. Heat created in the effluent via a source such as microwave or plasma may cause a formation of suspended particles. For example, some dissolved species, such as calcium and magnesium, may be converted to solid particulates upon heating, which may lead to scale deposit on the heating coils inside a home water heater if they are not removed from the water.

In certain embodiments, pre-conditioning techniques may be used to enhance the effluent treatment process. For example, in one embodiment, the effluent may be preheated to enhance flow and form small and better dispersed gas bubbles.

### EXAMPLE

An experiment was conducted where water containing methylene blue (methylene blue solution) was treated using the system 100.

The experiment was performed at microwave generated at 2.45 GHz by a microwave generator with maximum output power of 1.2 kW, and guided by a rectangular waveguide. The dominant mode supported by the waveguide is TE10 mode. The methylene blue solution was continuously circulated through the tube 102. Nitrogen gas was injected into the solution to generate gas bubbles. As previously mentioned, the gas bubbles rose up due to buoyancy. When the bubbles reached the region of enhanced electromagnetic field close to the electrode tip, the gas molecules inside the bubbles ionized to form intense plasma. The triggering of plasma enables coupling of microwave to plasma, leading to absorption of microwave power by plasma. The plasma was visible due to generation of optical emission.

After about 2 minutes exposure to the microwave induced plasma in gas bubbles, degradation of the methylene blue was observed and evident by change in color of the solution from dark blue to light blue. This degradation of the methylene blue occurred (at least in part) by the formation of radicals, including hydroxyl radicals, through the microwave induced plasma generation. These radicals, in particular hydroxyl radicals are highly reactive towards organics, demonstrating an ability to degrade organics.

The effectiveness of the microwave-generated plasma in breaking organic molecule was evaluated by transmittance of the solution and UV-visible absorption spectrum of the solution.

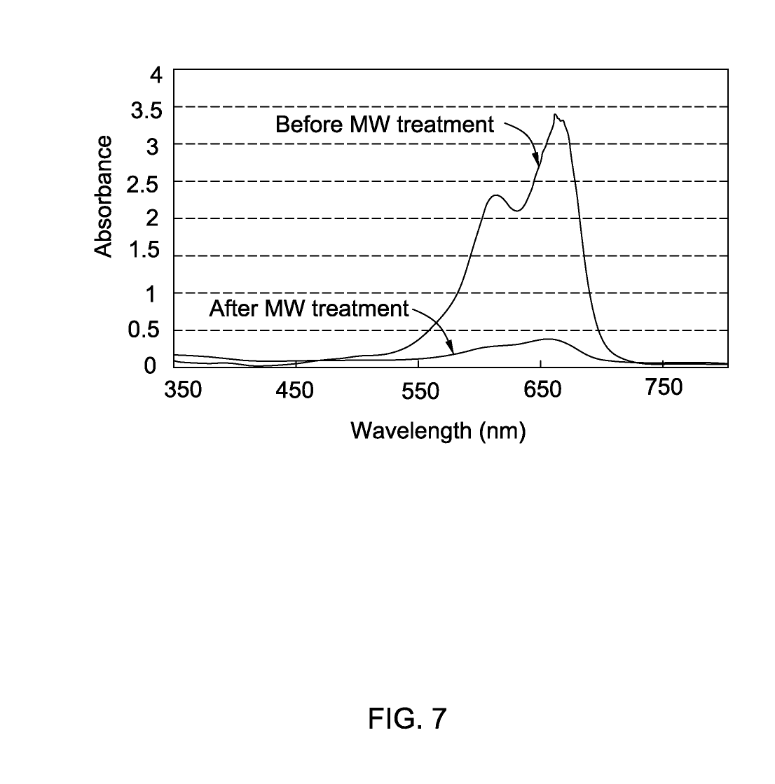

The transmittance of the solution (relative to air transmittance of 100), which for the pristine methylene blue solution before treatment was about 31, increased to about 79 after exposure to approximately 3 minutes of microwave-induced plasma. The disappearance of the color and increase in transmittance indicated photo-oxidation of methylene blue during exposure to the microwave-induced plasma. The UV-visible spectra of pristine and 3 minutes microwave exposed methylene blue solutions are shown in FIG. 7. The disappearance of the band around 660 nm indicates the photo-oxidation of most of the methylene blue within 3 minutes of exposure.

The experiment result shows that the method of using microwave-generated multi-bubble plasma for treating contaminated effluent provided by the present invention is very effective in degrading contaminates.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the subsequent claims.

1. A method for utilizing microwave generated multi-bubble plasma to treat an effluent, the method comprising:
(a) providing a microwave field;
(b) flowing an effluent and gas bubbles in the effluent across the microwave field;
(c) enhancing electromagnetic field in a path of the gas bubbles via an electrode;
(d) triggering plasma in the gas bubbles as the gas bubbles reach a region of enhanced electromagnetic field; and
(e) coupling microwave to the plasma.

2. The method according to claim 1, wherein the microwave field is provided by a single mode waveguide, and the electrode has a tip thereof positioned around where a maximum electric field of the microwave field is located.

3. The method according to claim 1, wherein the microwave field is provided by a multimode cavity.

4. The method according to claim 1, wherein the effluent is flowed across the waveguide by flowing through a tube made from a material transparent to the microwave.

5. The method according to claim 1, wherein the effluent is continuously circulated across the microwave field.

6. The method according to claim 1, wherein the electrode is designed to have an electric field enhancement factor higher than 1.0.

7. The method according to claim 1, wherein the electrode has a tip thereof positioned in the microwave field.

8. The method according to claim 1, wherein the electrode comprises particles dispersed in the flowing effluent and functioning as electrodes.

9. The method according to claim 8, wherein the particles are kept localized by means of fluidization or magnetic force.

10. The method according to claim 1, wherein further comprising passing a gas to the effluent to generate gas bubbles, through the electrode.

11. The method according to claim 1, further comprising stiffing the flowing effluent by mechanical mixing.

12. The method according to claim 1, further comprising promoting degradation of contaminant in the effluent by chemical additives.

13. The method according to claim 1, further comprising modifying conductivity of the effluent by chemical additives.

14. The method according to claim 1, further comprising applying ultrasound waves to oppose buoyancy forces on the gas bubbles.

15. The method according to claim 1, further comprising removing suspended solids in the effluent prior to the plasma generation.

16. The method according to claim 1, further comprising removing suspended solids from the effluent after exiting the reactor or between reactors.

17. The method according to claim 1, further comprising flowing the effluent flowed across the microwave field a second time or across a second microwave field, and repeating steps (c) to (e).

18. The method according to claim 17, wherein the second microwave field is provided by microwaves guided by a second waveguide.

19. The method according to claim 17, further comprising provide gas bubbles to the effluent flowing across the microwave field a second time or across a second microwave field.

20. The method according to claim 1, further comprising:
flowing a second effluent and second gas bubbles in the second effluent across the microwave field;
enhancing electromagnetic field in a path of the second gas bubbles via a second electrode, wherein the second electrode has a tip thereof positioned in the microwave field;
triggering plasma in the second gas bubbles as the second gas bubbles reach a region of enhanced electromagnetic field close to the second electrode tip; and
coupling microwave to the plasma.
